(19) United States
(12) Patent Application Publication
(10) Pub. No.: US 2013/0278116 A1
(43) Pub. Date: Oct. 24, 2013

(54) BRUSHLESS DC MOTOR

(71) Applicants: Jin Sun Min, Gyunggi-do (KR); Young Sun Yoo, Gyunggi-do (KR)

(72) Inventors: Jin Sun Min, Gyunggi-do (KR); Young Sun Yoo, Gyunggi-do (KR)

(73) Assignee: SAMSUNG ELECTRO-MECHANICS CO., LTD., Gyunggi-do (KR)

(21) Appl. No.: 13/532,529

(22) Filed: Jun. 25, 2012

(30) Foreign Application Priority Data
Apr. 18, 2012 (KR) 1020120040472

(51) Int. Cl. H02K 5/16

(52) U.S. Cl. 310/425

(57) ABSTRACT

Disclosed herein is a brushless DC motor that ensures stable driving of a shaft that rotates in a hollow of a bearing by using a bearing with a flat bottom surface and a tapered top. A contact height between an inner peripheral surface of the bearing and an outer peripheral surface of the shaft is larger than a contact height between an outer peripheral surface of the bearing and an inner peripheral surface of a bearing holder.

### CROSS REFERENCE TO RELATED APPLICATION

This application claims the benefit of Korean Patent Application No. 10-2012-0040472, filed on Apr. 18, 2012, entitled “Brushless DC Motor”, which is hereby incorporated by reference in its entirety into this application.

### BACKGROUND OF THE INVENTION

1. Technical Field

The present invention relates to a brushless DC motor.

2. Description of the Related Art

In general, a brushless DC motor is widely adopted as driving modules of a hard disk drive (HDD), an optical disk driver (ODD), and other recording media requiring high-speed rotation to serve to rotate a disk mounted on a turn table.

The brushless DC motor is formed by removing mechanical contact members such as a brush, a commutator, and the like that are provided to alternately supply current from a DC motor and an electrical rectification mechanism is provided instead of the mechanical contact members and is also called a brushless motor.

One example of the spindle motor is disclosed in Patent Document 1.

As already widely known, the brushless DC motor disclosed in Patent Document 1 is constituted by a shaft, a cylindrical bearing rotatably supporting the shaft, and a cylindrical bearing holder supporting the bearing.

The bearing supporting the shaft is assembled by pressing in a hollow of the bearing holder so that the center of the brushless DC motor having the structure is deviated when the brushless DC motor is driven.

The brushless DC motor generally supports the shaft rotatably by inserting a fluid into a micro-gap between the shaft and the bearing.

The bearing of the brushless DC motor of Patent Document 1 is just designed by simply placing emphasis on rotatably supporting the shaft without considering parameters such as wobble, skew, and the like.

As described above, the brushless DC motor in the related art requires an effort for ensuring stability of the shaft according to a trend in which the brushless DC motor is gradually made to be ultra-thin as well as an inner peripheral surface of the bearing is placed to be separated from an outer peripheral surface of the shaft by a predetermined gap.

While the brushless DC motor becomes ultra-thin, that is, an overall height of the brushless DC motor decreases, supporting areas of the bearing and the shaft are relatively reduced, and as a result, as the shaft that rotates within the bearing rotates with being deviated from a virtual central shaft, unnecessary vibration of the brushless DC motor is caused.

Accordingly, in order to solve the problems, those skilled in the art consider other schemes capable of improving supporting performance between the shaft and the bearing.

### PRIOR ART DOCUMENT

### Patent Document

(Patent Document 1) Korean Patent No. 10-1009205

### SUMMARY OF THE INVENTION

The present invention has been made in an effort to provide a brushless DC motor that can increase contact support between a shaft and a bearing.

According to a first preferred embodiment of the present invention, there is provided a brushless DC motor, including: a shaft; a bearing having a hollow cylindrical shape to rotatably support the shaft and including a taper on the top thereof; a bearing holder having the hollow cylindrical shape to support the bearing; a base fixing the bearing holder; a rotor including a hub and a magnet; and a stator including a core and a plurality of coils wound on the core and fixed to an outer peripheral surface of the bearing holder.

The taper may be inclined downwardly outward from the center of the bearing.

The height of an inner peripheral surface of the bearing may be larger than that of an outer peripheral surface of the bearing, such that a contact height between an inner peripheral surface of the bearing and the outer peripheral surface of the shaft may be larger than a contact height between the outer peripheral surface of the bearing and an inner peripheral surface of the bearing holder. The height of the inner peripheral surface of the bearing may be 1.1 times larger than that of the outer peripheral surface of the bearing.

The bottom surface of the bearing may be flat.

A slope surface which is inclined toward the center of the motor may be formed on the top of an inner peripheral surface of the bearing holder.

The taper of the bearing may be placed below the slope surface of the bearing holder.

According to a second preferred embodiment of the present invention, there is provided a brushless DC motor, including: a shaft; a bearing having a hollow cylindrical shape to rotatably support the shaft and including a taper on the top thereof; a bearing holder having the hollow cylindrical shape to support the bearing; a base fixing the bearing holder; a rotor including a hub and a magnet with a step portion on the bottom surface thereof; and a stator including a core and a plurality of coils wound on the core and fixed to an outer peripheral surface of the bearing holder.

The step portion may be placed opposite to the top of the bearing. The step portion may have the same shape and size of the top of the bearing to receive the top of the bearing therein.

The step portion may be formed on the bottom surface of the hub in a ring shape.

The taper may be inclined downwardly outward from the center of the bearing.

The height of an inner peripheral surface of the bearing may be larger than that of an outer peripheral surface of the bearing, such that a contact height between an inner peripheral surface of the bearing and the outer peripheral surface of the shaft may be larger than a contact height between the outer peripheral surface of the bearing and an inner peripheral surface of the bearing holder. The height of the inner peripheral surface of the bearing may be 1.1 times larger than that of the outer peripheral surface of the bearing.

The bottom surface of the bearing may be flat.

A slope surface which is inclined toward the center of the motor may be formed on the top of an inner peripheral surface of the bearing holder.

### BRIEF DESCRIPTION OF THE DRAWINGS

The above and other objects, features and advantages of the present invention will be more clearly understood from the following detailed description taken in conjunction with the accompanying drawings, in which:

FIG. 1A is a schematic cross-sectional view of a brushless DC motor according to a first preferred embodiment of the present invention;

FIG. 1B is a partially enlarged diagram of the brushless DC motor according to the first preferred embodiment of the present invention illustrated in FIG. 1A;

FIG. 2 is a graph diagram illustrating a relationship with wobble for a height length of a bearing in the brushless DC motor according to the first preferred embodiment of the present invention; and

FIG. 3 is a schematic partially enlarged diagram of a brushless DC motor according to a second preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

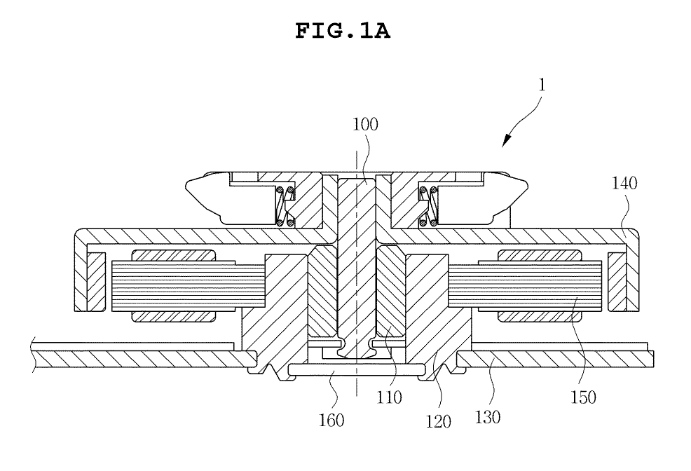

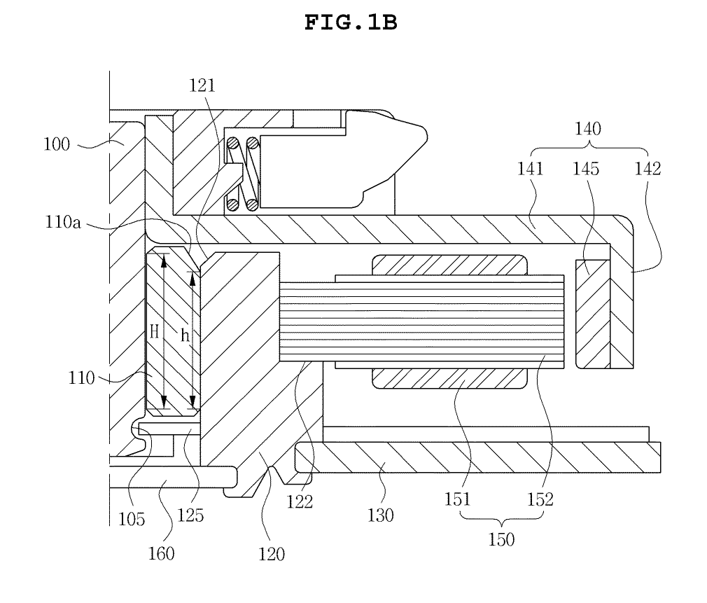

FIG. 1 is a diagram schematically illustrating a brushless DC motor according to a first preferred embodiment of the present invention. FIG. 1A is a cross-sectional view of a brushless DC motor according to a first preferred embodiment of the present invention. FIG. 1B is a partially enlarged diagram of the brushless DC motor according to the first preferred embodiment of the present invention illustrated in FIG. 1A.

The brushless DC motor 1 according to the preferred embodiment of the present invention includes a shaft 100, a bearing 110, a bearing holder 120, a base 130, a rotor 140, and a stator 150.

In detail, in the cup-shaped rotor 140, the shaft 100 is placed to coincide with a rotational center of a hub 141, that is, a central shaft and a magnet 145 are arranged inside a skirt portion 142 that extends vertically downward at an edge of the hub 141.

In the stator 150, a core 152 is seated on a bearing holder 120 joined through various methods including caulking or spinning on the base 130 which is flat and a coil 151 is wound on the circumference of the core 152. When current is applied to the coil 151, a magnetic field is generated around a tip of the core 152. The magnetic field provides magnetic force to the magnet 145 provided in the rotor 140 and thereafter, the magnetic force rotates the rotor 140 to drive the brushless DC motor 1.

The bearing 110 has a hollow cylindrical shape to rotatably receive the shaft 100. In this case, a fluid may be inserted in a micro-gap between an inner peripheral surface of the bearing 110 and an outer peripheral surface of the shaft 100. The bearing 110 is supported by the bearing holder 120 as illustrated in the figure.

The bearing holder 120 has the hollow cylindrical shape and closes an opened lower part of the bearing holder 120 through a supporter 160. The bearing 110 is inserted into an inner space formed by an inner peripheral surface of a hollow (no reference numeral) of the bearing holder 120 and the supporter 160. Herein, the bearing 110 may be fixed by the bearing holder 120 by means of a press-in method or a bonding method using a bonding agent.

A ring-shaped step portion is formed on an outer peripheral surface of the bearing holder 120, and as a result, the stator 150 is placed on a seating surface 122 which is stepped.

A slope surface 121 is formed on the top of an inner peripheral surface of the bearing holder 120. Since the slope surface 121 is inclined in an axial direction of the shaft 100 to extend an opened upper edge of the bearing holder 120. The bearing holder 120 having the extension structure helps the bearing 110 easily be inserted into the opened top of the bearing holder 120, and as a result, pressing-in the bearing 110 becomes easier.

Moreover, fixation groove portions (no reference numeral) are formed inside and outside a lower part of the bearing holder 120. The fixation groove portions fix the plated-shaped base 130 and the supporter 160. As necessary, the base 130 and the bearing holder 120 may be formed integrally with each other.

A stopper 125 that protrudes toward the center is provided in a lower part of the inner peripheral surface of the bearing holder 120, whereas a concave groove portion 105 is formed in a lower part of an outer peripheral surface of the shaft 100 opposite to the stopper 125. As illustrated in the figure, the stopper 125 is inserted into the concave groove portion 105 of the shaft 100 to prevent the shaft 100 from floating.

Alternatively, the supporter 160 includes a thrust washer (no reference numeral) for axially supporting the shaft 100.

The base 130 wholly supports the respective constituent members constituting the brushless DC motor 1 according to the preferred embodiment of the present invention and is a part installed to fix the brushless DC motor 1 to a device such as a hard disk drive. A printed circuit board with electronic elements such as an encoder, a connector, and a passive element is provided on a planar surface of the base 130.

The brushless DC motor 1 according to the first preferred embodiment of the present invention includes a hollow cylindrical bearing 110, and as a result, in particular, a taper 110a is formed on the top of the cylindrical bearing 110, whereas a bottom surface thereof may be flat. In other words, the bearing 100 has the taper 110a which is inclined outward to have a trapezoidal cross-sectional shape on the whole as illustrated in the figure.

The brushless DC motor 1 according to the preferred embodiment of the present invention may have a step portion (not illustrated) on the top of the bearing 110 instead of the taper 110a. The step portion is formed outside the top of the bearing 110, such that the height of an inner surface of the bearing 110 is larger than that of an outer surface of the bearing 110.

The taper 110a of the bearing 110 is placed below the slope surface 121 of the bearing holder 120. Contrary to this, the slope surface 121 of the bearing holder 120 may be placed below the taper 110a of the bearing 110. The present invention is not limited thereto and the slope surface 121 of the bearing holder 120 and the taper 110a of the bearing 110 may have the same height. The taper 110a and/or the slope surface 121 may improve flowability of the bonding agent between the bearing 110 and the bearing holder 120 at the time of bonding the bearing 110 and the bearing holder 120 and easily guide the bearing 110 into the bearing holder 120 while being pressed-in.

The height H of the inner peripheral surface of the bearing 110 is larger than the height h of the outer peripheral surface of the bearing 110 based on the bottom of the bearing 110. As a result, the height of a contact surface of the outer peripheral surface of the shaft 100 which comes close to the inner peripheral surface of the bearing 110 is the same as the height H of the inner peripheral surface of the bearing 110 and the height of a contact surface of the inner peripheral surface of the bearing holder 120 which comes close to or comes in contact with the outer peripheral surface of the bearing 110 is the same as the height h of the outer peripheral surface of the bearing 110.

As illustrated in the figure, the height of a contact surface between the bearing 110 and the shaft 100 is larger than the height of a contact surface of the bearing 110 and the bearing holder 120. Consequently, a contact length between the bearing 110 and the shaft 100 is larger than a contact length between the bearing 110 and the bearing holder 120, and as a result the shaft may be more certainly supported through the bearing 110. Therefore, the shaft 100 may achieve stable rotation while maximally removing vibration when the shaft 100 is driven in the bearing 110.

As described above, the micro-gap, that is, a tolerance is present between the bearing 110 and the shaft 100 according to the preferred embodiment of the present invention. The fluid is filled in the micro-gap to rotatably support the shaft 100. As already known to those skilled in the art, the shaft 100 should be rotated linearly to a virtual center shaft that extends in a longitudinal direction of the hollow (no reference numeral) of the bearing 110, but actually, the shaft rotates out of the center shaft due to the micro-gap, that is, the tolerance between the shaft 100 and the bearing 110.

In the preferred embodiment of the present invention, the inner peripheral surface of the bearing 110 is designed to extend longer than the outer peripheral surface of the bearing 110, and as a result, durability of the motor may be improved by minimizing the vibration of the motor by maximally increasing the same axial alignment of the shaft 100 and the virtual center shaft when the shaft 100 is rotatably driven in the bearing 110.

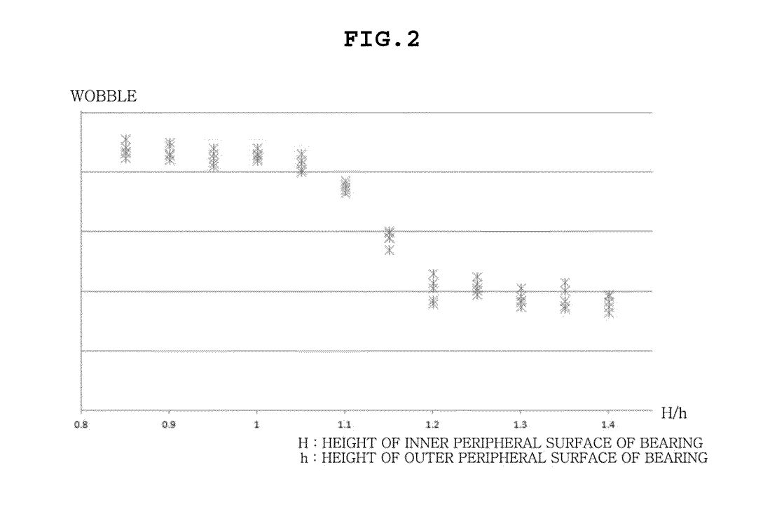

FIG. 2 is a graph diagram illustrating an occurrence degree of wobble to a ratio of the height of the inner peripheral surface of the bearing and the height of the outer peripheral surface of the bearing of the brushless DC motor according to the first preferred embodiment of the present invention.

In the brushless DC motor according to the first preferred embodiment of the present invention as a thin-film type brushless DC motor having a limited height, dynamic unbalance is caused through rotation of the shaft, thereby causing the vibration, for example, a wobble phenomenon.

In other words, the brushless DC motor according to the first preferred embodiment of the present invention can reduce the wobble phenomenon by controlling a ratio of the height H of the inner peripheral surface of the bearing arranged to come close to the outer peripheral surface of the shaft 100 (see FIG. 1A) and the height h of the bearing arranged to come close to the inner peripheral surface of the bearing holder 120 (see FIG. 1A).

FIG. 2 illustrates an occurrence degree of wobble by differentiating the ratio of the height H of the inner peripheral surface of the bearing and the height h of the outer peripheral surface of the bearing in the brushless DC motor having the same size and the same structure. Herein, a Y axis of FIG. 2 represents the occurrence degree of the wobble and an X axis represents the height H of the inner peripheral surface of the bearing/the height h of the outer peripheral surface of the bearing.

Referring to FIG. 2, in the bearing 110 (see FIG. 1B) according to the preferred embodiment of the present invention, it can be verified that the occurrence degree of the wobble phenomenon is remarkably reduced under the condition of the height H of the inner peripheral surface of the bearing/the height h of the outer peripheral surface of the bearing ≧1.1.

As such, based on the fact that the wobble can be reduced only when the height H of the inner peripheral surface of the bearing is 1.1 times larger than the height h of the outer peripheral surface of the bearing, the brushless DC motor according to the preferred embodiment of the present invention is configured to have a bearing with a trapezoidal cross-sectional shape in which the height H of the inner peripheral surface of the bearing is larger than the height h of the outer peripheral surface of the bearing.

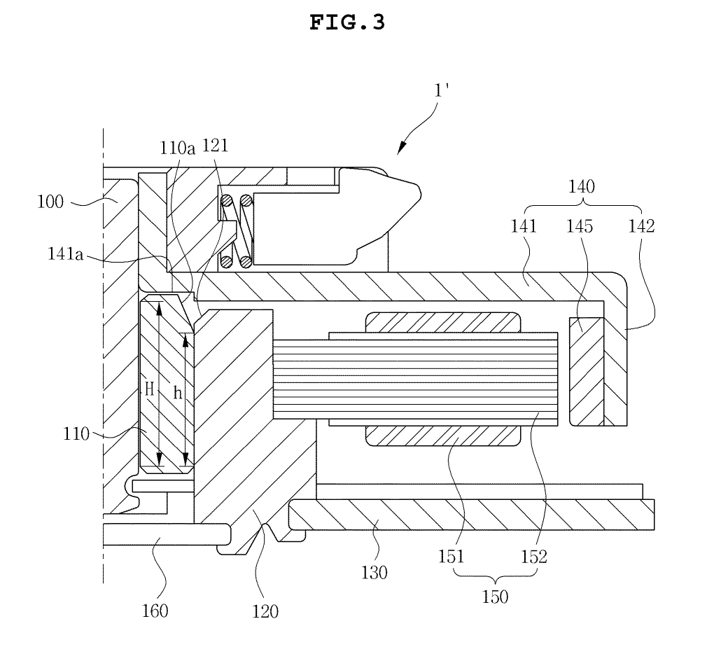

FIG. 3 is a schematic partially enlarged diagram of a brushless DC motor according to a second preferred embodiment of the present invention. The brushless DC motor 1′ according to the second preferred embodiment of the present invention illustrated in FIG. 3 is similar as the brushless DC motor 1 of the first preferred embodiment illustrated in FIGS. 1A and 1B except for the hub 141. Similar or the same constituent members will not be herein excluded in order to help clear understanding of the present invention.

As illustrated in FIG. 3, the brushless DC motor 1′ according to the second preferred embodiment of the present invention includes the rotor 140 in which the shaft 100 is placed on a center shaft line which coincides with the rotational center of the hub 141. In other words, the cup-shaped rotor 140 includes the disk-shaped hub 141 and the skirt portion 142 mounted with the magnet 145.

The rotor 140 as a rotating structure provided to be rotatable to the stator 150 by forming an electric field for rotation of the hub 141 includes the ring-shaped magnet 145 placed opposite to the core 152 by a predetermined gap on an inner peripheral surface of the skirt portion 142 and the magnet 145 forming the magnetic field generates electromagnetic force between the magnetic field and the electric field formed in the coil 151. The rotor 140 of the brushless DC motor is rotated by the electromagnetic force. The hub 141 includes a disk chucking (no reference numeral) that chucks a disk used for the purpose of reproducing a signal record.

A ring-shaped step portion 141a is formed on the bottom surface of the hub 141 of the rotor 140. In particular, the step portion 141a is formed in an upper part of the bearing 110, in more detail, at a position opposite to the taper 110a. The step portion 141a is stepped along the bottom surface of the center of the hub 141, but the step portion 141a is not limited thereto and may have a ring-shaped concave groove shape.

Herein, the step portion 141a is formed to have a shape and a size to receive the taper 110a in the upper part of the bearing 110.

In the brushless DC motor 1′ according to the second preferred embodiment of the present invention, the height H of the inner peripheral surface of the bearing 110 may be extended as high as a step height of the step portion 141a under a limited motor height of a ultra-thin type brushless DC motor, such that a coaxial shaft of the shaft 100 may more effectively coincide with the center shaft of the bearing 100.

Moreover, in the brushless DC motor 1′ according to the second preferred embodiment of the present invention, a step portion is formed on an upper outer peripheral surface of the bearing 110 instead of the taper 110a on the top of the bearing 110, such that the height of the inner to peripheral surface of the bearing and the height of the outer peripheral surface of the bearing may be different from each other. That is, the height H of the inner peripheral surface of the bearing 110 of the present invention is larger than the height h of the outer peripheral surface of the bearing 110.

According to a preferred embodiment of the present invention, stable driving of a shaft that rotates within a hollow of a bearing is provided by improving contact support force between the shaft and the bearing.

In the brushless DC motor which is ultra-thin and decreases in overall height, the bearing and/or the shaft which were used in the related art, other than the bearing ensuring an optimal contact state between the shaft and the bearing can be adopted as it is.

Rotation driving of the shaft can be implemented by improving connection performance between the bearing and a bearing holder.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A brushless DC motor, comprising:
a shaft;
a bearing having a hollow cylindrical shape to rotatably support the shaft and including a taper on the top thereof;
a bearing holder having the hollow cylindrical shape to support the bearing;
a base fixing the bearing holder;
a rotor including a hub and a magnet; and
a stator including a core and a plurality of coils wound on the core and fixed to an outer peripheral surface of the bearing holder.

2. The brushless DC motor as set forth in claim 1, wherein the taper is inclined downwardly outward from the center of the bearing.

3. The brushless DC motor as set forth in claim 1, wherein the height of an inner peripheral surface of the bearing is larger than that of an outer peripheral surface of the bearing.

4. The brushless DC motor as set forth in claim 1, wherein the bottom surface of the bearing is flat.

5. The brushless DC motor as set forth in claim 1, wherein a slope surface is formed on the top of an inner peripheral surface of the bearing holder.

6. The brushless DC motor as set forth in claim 1, wherein the taper of the bearing is placed below the slope surface of the bearing holder.

7. The brushless DC motor as set forth in claim 1, wherein the top of the bearing is stepped along an outer surface thereof.

8. The brushless DC motor as set forth in claim 3, wherein the height of the inner peripheral surface of the bearing is 1.1 times larger than that of the outer peripheral surface of the bearing.

9. A brushless DC motor, comprising:
a shaft;
a bearing having a hollow cylindrical shape to rotatably support the shaft and including a taper on the top thereof;
a bearing holder having the hollow cylindrical shape to support the bearing;
a base fixing the bearing holder;
a rotor including a magnet and a hub with a step portion on the bottom surface thereof; and
a stator including a core and a plurality of coils wound on the core and fixed to an outer peripheral surface of the bearing holder.

10. The brushless DC motor as set forth in claim 9, wherein the step portion is placed opposite to the top of the bearing.

11. The brushless DC motor as set forth in claim 9, wherein the step portion has a ring shape, which is formed on the bottom surface of the hub.

12. The brushless DC motor as set forth in claim 9, wherein the taper is inclined downwardly outward from the center of the bearing.

13. The brushless DC motor as set forth in claim 9, wherein the height of an inner peripheral surface of the bearing is larger than that of an outer peripheral surface of the bearing.

14. The brushless DC motor as set forth in claim 9, wherein the bottom surface of the bearing is flat.

15. The brushless DC motor as set forth in claim 9, wherein a slope surface is formed on the top of an inner peripheral surface of the bearing holder.

16. The brushless DC motor as set forth in claim 9, wherein the top of the bearing is stepped along an outer surface thereof.

17. The brushless DC motor as set forth in claim 13, wherein the height of the inner peripheral surface of the bearing is 1.1 times larger than that of the outer peripheral surface of the bearing.
